(19) United States
(12) Patent Application Publication
(10) Pub. No.: US 2008/0232121 A1
(43) Pub. Date: Sep. 25, 2008

(54) Working lamp base of barbeque grill

(75) Inventor: Jih-Shyong Lin, Taipei City (TW)

Correspondence Address: BACON & THOMAS, PLLC, 625 SLATERS LANE, FOURTH FLOOR, ALEXANDRIA, VA, 22314-1176, US

(73) Assignee: Huang-Hsi Hsu, Taipei (TW)

(21) Appl. No.: 11/727,020

(22) Filed: Mar. 23, 2007

(51) Int. Cl. F21V 21/00

(52) U.S. Cl. 362/396

(57) ABSTRACT

A working lamp base of a barbeque grill includes a base with two protruding portions extended in the same direction from a lateral side of the base and forming a recession between the protruding portion and the base; a rack mount disposed on the base and proximate to a lateral side of each protruding portion, and corresponding to the position of said recession; and at least one lamp, each including a lamp body and a first movable supporting portion, and an end of said first movable supporting portion is coupled to one of said protruding portions and another end of the first movable supporting portion is coupled to the lamp body.

### FIELD OF THE INVENTION

The present invention relates to a working lamp base, and more particularly to a working lamp base of a barbeque grill.

### BACKGROUND OF THE INVENTION

As living standard improves, people pay more attentions to leisure activities, and thus barbeque gradually becomes a popular activity for families and friends. Obviously, people always take the user-friendliness, safety and practicability of barbeque tools such as a barbeque grill or an ignition gun into consideration when they select barbeque tools. Therefore, the competition of the market of various different barbeques becomes increasingly severer, and barbeque tool manufacturers and designers spare no effort to enhance the practicability and convenience of their products in order to gain market share and obtain the loyalty of extensive consumers.

Referring to FIG. 1 for a conventional rotisserie 60 available in the market, the rotisserie 60 generally includes: a hollow barbeque grill 61 with a U-shape cross section, a containing space 611 of the barbeque grill 61 for containing related barbeque tools and materials such as a stove, a mesh and charcoals (not shown in the figure); a fixing stand 62 and a motor mount 63 disposed on two corresponding sidewalls of the barbeque grill 61 respectively, wherein the motor mount 63 is provided for mounting a motor holder 64, and the motor holder 64 has an illumination portion 641; an axle hole 642 disposed on a lateral side of the motor holder 64, such that a rod 70 can be inserted precisely into the axle hole 642, and another end of the rod 70 is disposed across a notch 624 of the fixing stand 62, and a pair of tines 651 are disposed at appropriate positions of a pit, such that after a piece of barbeque food 80 is fixed onto the rod 70 and the tines 651, the barbeque food 80 can be driven to rotate by the motor holder 64 and barbequed by charcoal fire in the barbeque grill 61 for cooking the barbeque food 80.

The illumination portion 641 is provided for illuminating the surroundings of the hollow barbeque grill 61 in a dark or fuzzy environment, and providing light to the barbeque food 80 or barbeque tools, so that users can observe and determine whether or not the barbeque food 80 is cooked to prevent eating uncooked food. Although the illumination portion 641 can illuminate objects such as barbeque food 80 or barbeque tools around the barbeque grill 61, if the illumination portion 641 comes with a low wattage or the light source at a lateral side of the illumination portion 641 is blocked by a large piece of barbeque food 80, such that the light source of the illumination portion 641 cannot be projected onto another lateral side of the barbeque food 80, and then users cannot know whether or not another side of the barbeque food 80 is heated evenly, and users have to rotate the direction of setting the rod 70 from time to time in order to project the light source of the illumination portion 641 directly onto another side of the barbeque food 80. Unquestionably, such arrangement consumes much time and efforts.

In generally, a user may set up another fixed clamp lamp 90 to solve the aforementioned problem, if the user is not willing to rotate the direction of the rod 70. In FIG. 1, the fixed clamp lamp 90 has a lamp body 91 and a clamp 92, and the clamp 92 can be clamped at any position around the hollow barbeque grill 61 as needed for illuminating the barbeque food 80 or the barbeque tools in the hollow barbeque grill 61, but the fixed clamp lamp 90 totally relies on the clamp around the barbeque grill 61 to support the lamp, so that when the motor holder 64 is operated, the fixed clamp lamp 90 will produce vibrations which may separate the fixed clamp lamp 90 from the barbeque grill 61 or damage the fixed clamp lamp 90.

For some motor holders that do not come with an illumination portion, consumers have to purchase a motor holder having an illumination portion in order to have a barbeque, and thus incurring additional cost to the consumers. Although the fixed clamp lamp 90 can be used for providing sufficient light for the barbeque grill 61, it is still very inconvenient and deficient, and other problems or even risks may occur. Thus, it demands immediate attentions and feasible solutions to overcome the aforementioned shortcomings of the prior art.

### SUMMARY OF THE INVENTION

In view of the foregoing shortcomings of the prior art, the inventor of the present invention based on years of experience in the related industry to conduct extensive researches and experiments, and finally developed a working lamp base of a barbeque grill of the present invention, comprising a base, a rack mount and at least one lamp, the rack mount is installed on a lateral side of the base and hanged on a barbeque grill, and two protruding portions are extended in the same direction from the base and disposed proximate to a lateral side of the rack mount, and a recession is formed between each protruding portion and the base and disposed corresponding to the rack mount, wherein each lamp is movably installed to an end of at least one protruding portion.

It is a primary objective of the present invention to provide the working lamp base installed onto a fixing stand of at the sidewall of a barbeque grill through the rack mount, for connecting an end of a rod that pierces through the barbeque food to a motor holder, and then another end can be built across the fixing stand, passed through the recession, and disposed on a notch of the fixing stand, such that the working lamp base can be installed onto a lateral side of the barbeque grill. Now, the lamp can be used for illuminating the surrounding of the barbeque grill and providing a sufficient light source, and the recession of the working lamp base also facilitates users to access the rod on the barbeque grill without causing any inconvenience for putting the rod and barbeque food in the barbeque grill.

Another objective of the present invention is to install the two protruding portions having a washer movably disposed on a lateral side of the rack mount, wherein the washer has an arc notch disposed at the position facing the recession, and another end of the rod is disposed across the recession and set on the arc notch. The two protruding portions further install a plurality of equidistant concave holes, and both ends of the washer separately have a penetrating hole corresponding to each concave hole, and the washer can be fixed onto the two protruding portions by passing a locking bolt through each penetrating hole and the concave hole, such that the washer can be used for adjusting the two protruding portions horizontally according to the height of the rod.

A further objective of the present invention is to install a power supply portion (such as a battery or a rectifier) in the hollow base for supplying sufficient electric power for the operation of the lamp and preventing users from being stumbled by the power cord during a barbeque activity.

Another objective of the present invention is to provide a working lamp base further comprising a plurality of indentations and a pressing board, and the indentations are disposed on a lateral side of any two adjacent opposite protruding portions, and two of the corresponding indentations are movably embedded into both ends of a lateral side of the pressing board, and a space enclosed between the pressing board and the base is provided for accommodating a lateral side of a working platform, and the pressing board has at least one screw hole, such that a screw nut can be extended into each screw hole, and each secured screw nut produces a stress towards the working platform, and another end of the compressing screw nut presses against the working platform, such that the working lamp base will not come off from the working platform.

To make it easier for our examiner to understand the objective, technical characteristics and effects of the present invention, preferred embodiments will be described with accompanying drawings as follows:

### BRIEF DESCRIPTION OF THE DRAWINGS

FIG. 1 is a schematic view of a rotisserie and a conventional fixed clamp lamp;

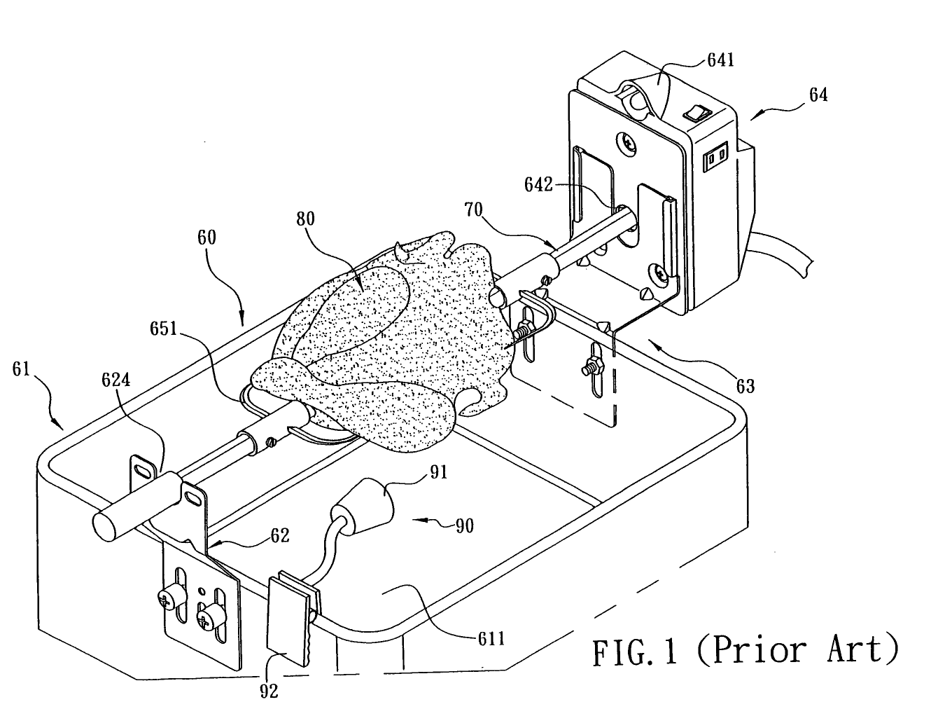

FIG. 2 is a schematic view of a structure of the present invention;

FIG. 3 is a schematic view of an application in accordance with a first preferred embodiment of the present invention;

FIG. 4 is a schematic view of an application in accordance with a second preferred embodiment of the present invention; and

FIG. 5 is a schematic view of an application in accordance with a third preferred embodiment of the present invention.

### DETAILED DESCRIPTION OF THE PREFERRED EMBODIMENTS

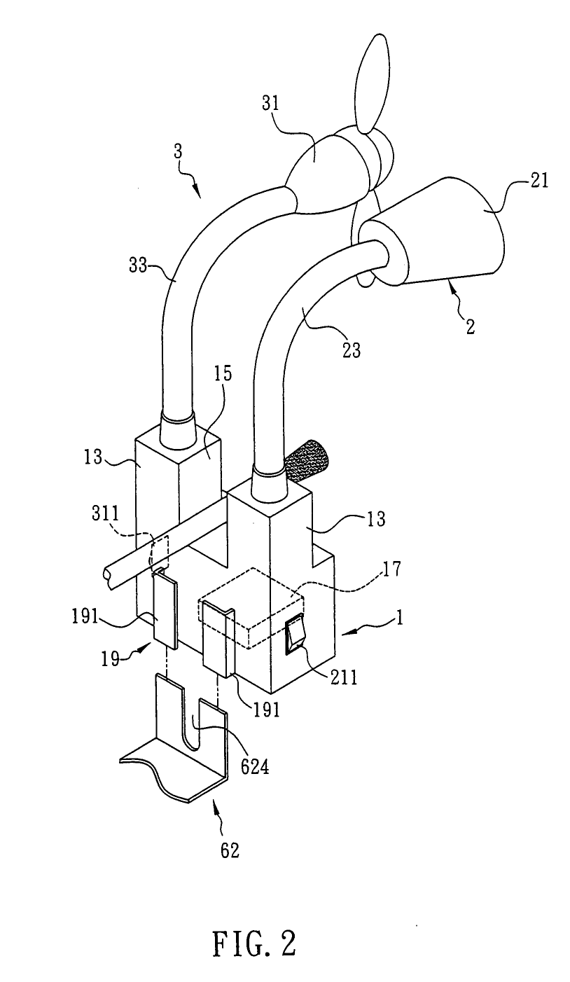

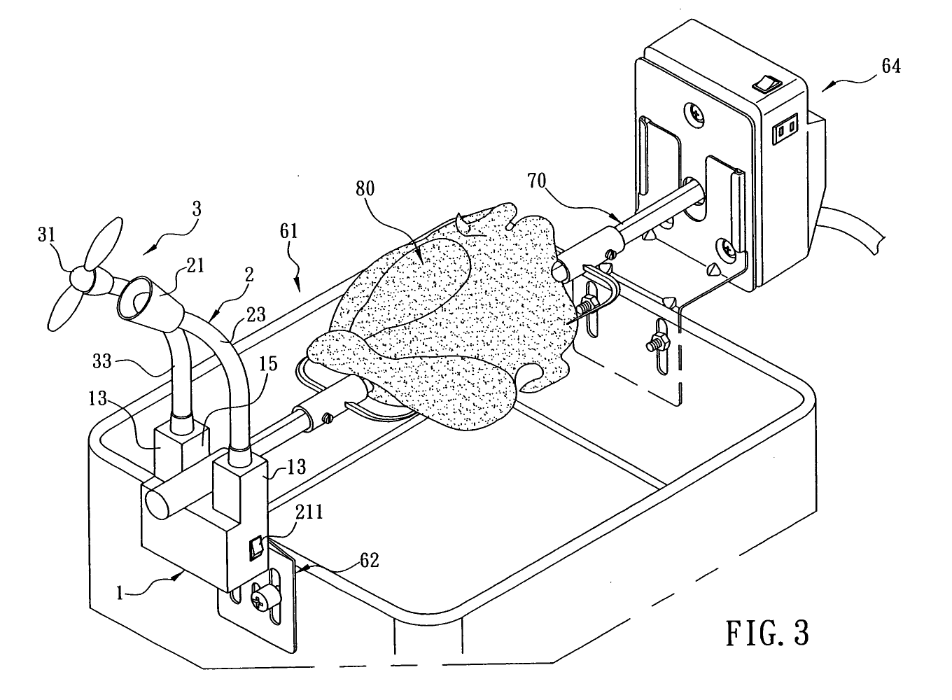

Referring to FIGS. 2 and 3 for a working lamp base applied in a barbeque grill, the working lamp base has two protruding portions 13 extended in the same direction from a lateral side of a base 1, a recession 15 disposed between the protruding portions 13 and the base 1, and a lamp 2 installed at an end of at least one protruding portion 13. The lamp 2 includes a lamp body 21 (such as a bulb or an LED lamp) and a first movable supporting portion 23, and an end of the first movable supporting portion 23 is coupled to the protruding portion 13, and another end of the first movable supporting portion 23 is coupled to the lamp body 21. The base 1 is hollow and capable of installing a power supply portion 17 (such as a battery or a rectifier) for providing sufficient electric power for the operation of the lamp 2. Further, the base 1 has a rack mount 19 disposed proximate to a lateral side of each protruding portion 13 and corresponding to the recession 15, and the rack mount 19 of a first preferred embodiment of the present invention is comprised of at least two parallel embedding latches 191 sheathed onto a fixing stand 62 that is disposed on a sidewall of a barbeque grill 61, so that the working lamp base can be hanged onto the barbeque grill 61, while an end of a rod that penetrates into a piece of barbeque food 80 is coupled to a motor holder 64, and another end of the rod is disposed across the fixing stand 62, passed through the recession 15 between the two protruding portions 13, and disposed on a notch 624 of the fixing stand 62. The first movable supporting portion 23 could be any curved plastic pipe (such as a serpentine pipe), that can freely change the direction of a light source emitted from the lamp body 21. The lamp 2 can be turned on by switching a first switch 211 on a lateral side of the base 1 to conduct an electrical connection between the power supply portion 17 and the lamp body 21, or emit a light source towards the barbeque food 80 on the barbeque grill 61, or a target outside the hollow barbeque grill 61. In addition to the recession 15 of the working lamp base that facilitates users to set the rod 70 across the barbeque grill 61 or remove the rod 70 from the barbeque grill 61, the lamp 2 can also light up the surrounding of the barbeque grill 61.

In general, a barbeque activity becomes inconvenient if it is held in a dark or fuzzy environment, and the smoke and grease brought by cooking the barbeque food 80 in the barbeque grill 61 also irritates people's eyes and leaves odors on their clothes. In a second preferred embodiment of the present invention as shown in FIGS. 2 and 3, a lamp 2 is installed at an end of one of the two protruding portions 13, and a fan device 3 is installed at an end of the remaining protruding portion 13 without the lamp 2. The fan device 3 includes a fan body 31 and a second movable supporting portion 33, and an end of the second movable supporting portion 33 is coupled to an end of the protruding portion 13, and another end of the second movable supporting portion 33 is coupled to the fan body 31, and the second movable supporting portion 33 is any curved plastic pipe (such as a serpentine pipe) that can freely change the direction of air flow of the fan body 31, and the power supply portion 17 is used for providing sufficient electric power for the operation of the fan device 3. The fan device 3 can be turned on by switching a second switch 311 on a lateral side of the base 1 to conduct an electric connection between the power supply portion 17 and the fan body 31, so as to extract the smoke and grease from the hollow barbeque grill 61.

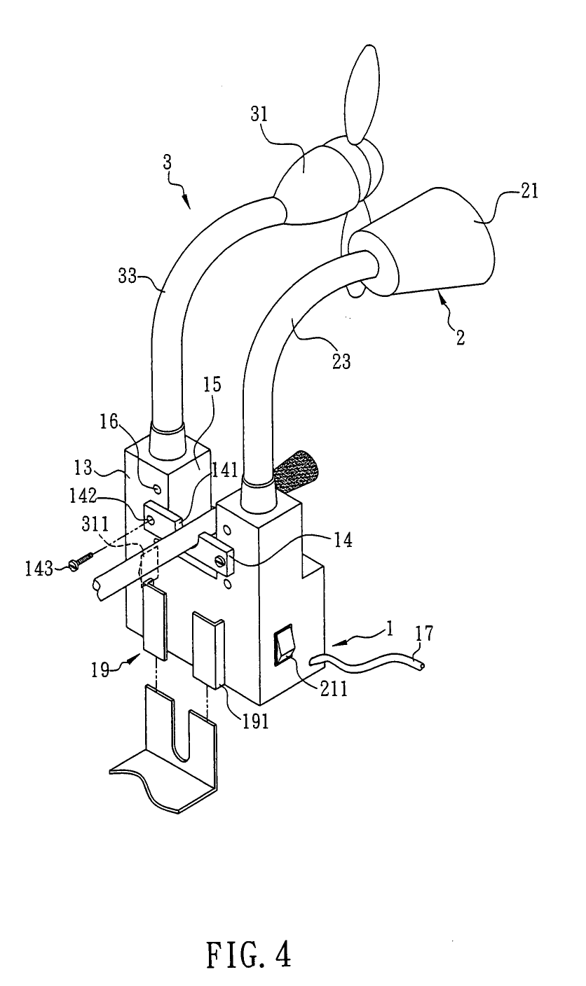

Referring to FIGS. 2 and 4 for a third preferred embodiment of the present invention, the two protruding portions 13 have a washer 14 movably installed on a lateral side of the rack mount 19, the washer 14 has an arc notch 141 disposed at a position facing towards the recession 15, and another end of the rod 70 is set across the recession 15 and disposed on the arc notch 141 of the washer 14, such that the rod 70 can be driven by the motor holder 64 to rotate on the arc notch 141. The two protruding portions 13 further include a plurality of equidistant concave holes 16, and both ends of the washer 14 separately have a penetrating hole 142 corresponding to each concave hole 16, and a locking bolt 143 is passed sequentially through each penetrating hole 142 and the concave hole 16 for fixing the washer 14 onto the two protruding portions 13. In the meantime, the washer 14 can be used for horizontally adjusting a side of the two protruding portions 13 according to the height of the rod 70.

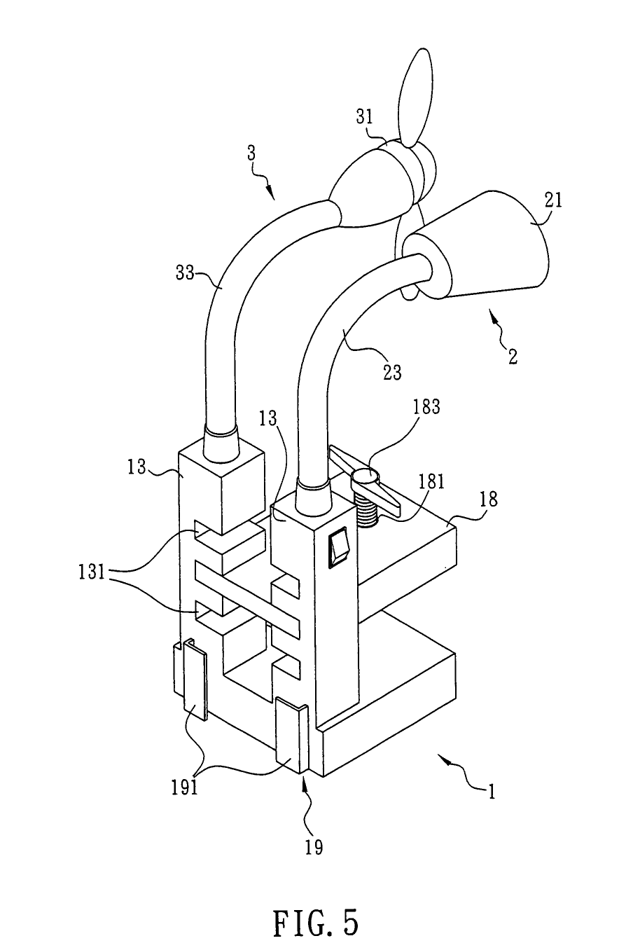

The working lamp base can be installed at a barbeque grill or clamped on a working platform as adopted in the working lamp base of the fourth preferred embodiment of the present invention. In FIG. 5, the two protruding portions 13 have a plurality of corresponding indentations 131 disposed on a lateral side facing each other, and a pressing board 18 is installed movably with the two corresponding indentations 131, so that both ends of the pressing board 18 are embedded movably into the two corresponding indentations 131, and the pressing board 18 has at least one screw hole 181, and a compressing screw nut 183 is extended into each screw hole 181. If a user wants to clamp the working lamp base onto a working platform (such as a tabletop or a slab), the user can select an indentation 131 at a position of an appropriate height based on the thickness of a lateral side of the working platform for embedding a lateral side of the pressing board 18. After the lateral side of pressing board 18 is embedded into the two corresponding indentations 131, the space formed between the pressing board 18 and the base 1 can be used for accommodating the working platform precisely, so that after the lateral side of the working platform is extended into the space enclosed between the pressing board 18 and the base 1, an end of each compressing screw nut 183 applies a torque in the direction towards the working platform, and another end of each compressing screw nut 183 presses against the working platform to press the working platform. With the pressing of each compressing screw nut 183 on the working platform, the pressing board 18 and the base 1 can be clamped onto the working platform, and thus the working lamp base will not fall off from the working platform.

While the invention has been described by means of specific embodiments, numerous modifications and variations could be made thereto by those skilled in the art without departing from the scope and spirit of the invention set forth in the claims. For instance, the power supply portion 17 can be installed outside the working lamp base instead of in the working lamp base, for obtaining sufficient electric power for the operation of the lamp 2 and the fan device 3.

What is claimed is:

1. A working lamp base of a barbeque grill, comprising:
a base, with two protruding portions extended in the same direction from a lateral side of said base, and forming a recession between said protruding portions and said base;
a rack mount, disposed on said base and proximate to a lateral side of said each protruding portion, and corresponding to the position of said recession; and
at least one lamp, each including a lamp body and a first movable supporting portion, and an end of said first movable supporting portion being coupled to one of said protruding portions and another end of said first movable supporting portion being coupled to said lamp body.

2. The working lamp base of claim 1, wherein said two protruding portions have a washer movably installed on a lateral side having said rack mount, and said washer has an arc notch disposed at a position facing said recession.

3. The working lamp base of claim 2, further comprising a fan device disposed on said protruding portion without installing a lamp, and said fan device including a fan body and a second movable supporting portion, and an end of said second movable supporting portion being coupled to an end of said protruding portion, and another end of said movable supporting portion being coupled to said fan body.

4. The working lamp base of claim 1, wherein said working lamp base further comprising:
a plurality of indentations, disposed on a lateral side of any two adjacent opposite protruding portions; and
a pressing board, with both ends movably embedded into said two corresponding indentation, and having a space defined between said pressing board and said base for containing a working platform, and said pressing board having at least one screw hole penetrating said pressing board.

5. The working lamp base of claim 3, wherein said working lamp base further comprising:
a plurality of indentations, disposed on a lateral side of any two adjacent opposite protruding portions; and
a pressing board, with both ends movably embedded into said two corresponding indentation, and having a space defined between said pressing board and said base for containing a working platform, and said pressing board having at least one screw hole penetrating said pressing board.

6. The working lamp base of claim 4, wherein said first movable supporting portion is a curved plastic pipe.

7. The working lamp base of claim 5, wherein said first movable supporting portion is a curved plastic pipe.

8. The working lamp base of claim 4, wherein said second movable supporting portion is a curved plastic pipe.

9. The working lamp base of claim 5, wherein said second movable supporting portion is a curved plastic pipe.

10. The working lamp base of claim 4, wherein said rack mount has at least two embedding latches parallel with each other.

11. The working lamp base of claim 5, wherein said rack mount has at least two embedding latches parallel with each other.

12. The working lamp base of claim 2, wherein said two protruding portions further includes a plurality of concave holes; and
said washer has a penetrating hole disposed separately on both ends of said washer and corresponding to said each concave hole, and a locking bolt is passed sequentially through said each penetrating hole and said concave hole, for fixing said washer onto said two protruding portions.
